(19) United States
(12) Patent Application Publication
(10) Pub. No.: US 2012/0218206 A1
(43) Pub. Date: Aug. 30, 2012

(54) ELECTRONIC DEVICE, OPERATION CONTROL METHOD, AND STORAGE MEDIUM STORING OPERATION CONTROL PROGRAM

(75) Inventors: Takayuki SATO, Yokohama-shi (JP); Makiko HOSHIKAWA, Osaka (JP); Tomohiro SHIMAZU, Osaka (JP)

(73) Assignee: KYOCERA CORPORATION, Koyoto (JP)

(21) Appl. No.: 13/404,126

(22) Filed: Feb. 24, 2012

(30) Foreign Application Priority Data
Feb. 24, 2011 (JP) 2011-039099

(51) Int. Cl. G06F 3/041

(52) U.S. Cl. 345/173

(57) ABSTRACT

According to an aspect, an electronic device, includes a display unit, a contact detecting unit, and a control unit. The display unit displays a first image. The contact detecting unit detects a contact. When a sweep operation is detected by the contact detecting unit while the first image is displayed on the display unit, the control unit causes a second image to be displayed over the first image. The second image is extended from a first position at which the sweep operation is detected at first or an end portion of the display unit near the first position.

### CROSS-REFERENCE TO RELATED APPLICATIONS

This application claims priority from Japanese Application No. 2011-039099, filed on Feb. 24, 2011, the content of which is incorporated by reference herein in its entirety.

### BACKGROUND

1. Technical Field

The present disclosure relates to an electronic device, an operation control method, and a storage medium storing therein an operation control program.

2. Description of the Related Art

Portable electronic devices such as mobile phones can be used at various places. For this reason, for example, when a portable electronic device is used in a crowded train, another person may peep at the portable electronic device from behind or from the side. As a countermeasure against such a peep, portable electronic devices that can display an image in a display mode in which a screen could be hardly seen from the side and portable electronic devices that make a screen hardly seen from the side by arranging a special film on a surface thereof have been proposed. Further, information display devices that detect a surrounding situation and display an alarm when any other person is likely to peep have been proposed (see Japanese Patent Application Laid-Open (JP-A) No, 2009-93399).

Peeping in a direction other than from the front can be prevented by a hardware configuration, for example, by changing a liquid crystal display (LCD) or a film on a surface. However, even in this case, it is hard to prevent peeping from behind or the like. Further, a configuration of suppressing a peep by a hardware configuration requires great care or makes a structure complicated. In the technique disclosed in JP-A No. 2009-93399, it may be difficult to cope with even though that warning is made. Furthermore, an operation is complicated and so may be difficult to be intuitively understood.

For the foregoing reasons, there is a need for an electronic device, an operation control method, and an operation control program capable of reducing, by a simple operation, a possibility that a display content will be peeped.

### SUMMARY

According to an aspect, an electronic device, includes a display unit, a contact detecting unit, and a control unit. The display unit displays a first image. The contact detecting unit detects a contact. When a sweep operation is detected by the contact detecting unit while the first image is displayed on the display unit, the control unit causes a second image to be displayed over the first image. The second image is extended from a first position at which the sweep operation is detected at first or an end portion of the display unit near the first position.

According to another aspect, an operation control method is executed by an electronic device including a display unit and a contact detecting unit. The operation control method includes: displaying a first image on the display unit; detecting a sweep operation by the contact detecting unit while the first image is displayed on the display unit; and displaying a second image over the first image when the sweep operation is detected. The second image is extended from a first position at which the sweep operation is detected at first or an end portion of the display unit near the first position.

According to another aspect, a non-transitory storage medium that stores an operation control program. When executed by an electronic device which includes a display unit and a contact detecting unit, the operation control program causes the portable electronic device to execute: displaying a first image on the display unit; detecting a sweep operation by the contact detecting unit while the first image is displayed on the display unit; and displaying a second image over the first image when the sweep operation is detected. The second image is extended from a first position at which the sweep operation is detected at first or an end portion of the display unit near the first position.

### BRIEF DESCRIPTION OF THE DRAWINGS

FIG. 1 is a perspective view of a mobile phone;

FIG. 2 is a front view of the mobile phone;

FIG. 3 is a block diagram of the mobile phone;

FIG. 4 is a diagram illustrating an example of control executed by a control unit according to an operation detected by a contact sensor;

FIG. 5 is a diagram illustrating an example of control executed by the control unit according to an operation detected by the contact sensor;

FIG. 6 is a diagram illustrating an example of control executed by the control unit according to an operation detected by the contact sensor;

FIG. 7 is a diagram illustrating an example of control executed by the control unit according to an operation detected by the contact sensor;

FIG. 8 is a diagram illustrating an example of control executed by the control unit according to an operation detected by the contact sensor;

FIG. 9 is a flowchart illustrating an operation of the mobile phone; and

FIG. 10 is a flowchart illustrating an operation of the mobile phone.

### DETAILED DESCRIPTION

The present invention will be described in detail with reference to the drawings. It should be noted that the present invention is not limited by the following explanation. In addition, this disclosure encompasses not only the components specifically described in the explanation below, but also those which would be apparent to persons ordinarily skilled in the art, upon reading this disclosure, as being interchangeable with or equivalent to the specifically described components.

In the following description, a mobile phone is used to explain as an example of the electronic device, however, the present invention is not limited to mobile phones. Therefore, the present invention can be applied to various types of devices (portable electronic devices and/or stationary electronic devices), including but not limited to personal handyphone systems (PHS), personal digital assistants (PDA), portable navigation units, personal computers (including but not limited to tablet computers, netbooks etc.), media players, portable electronic reading devices, and gaming devices.

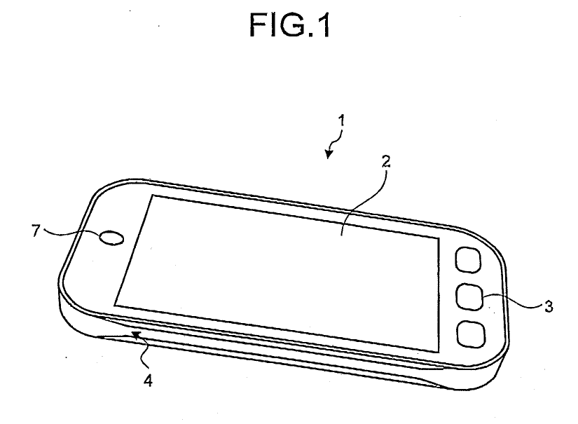

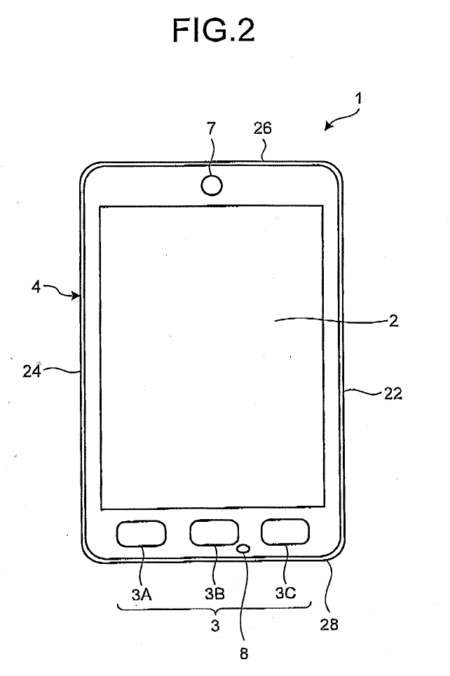

First, an overall configuration of a mobile phone 1 as an electronic device according to an embodiment will be described with reference to FIGS. 1 and 2. FIG. 1 is a perspective view of the mobile phone 1. FIG. 2 is a front view of the mobile phone 1. As illustrated in FIGS. 1 and 2, the mobile phone 1 includes a housing that has an approximately hexahedral shape having two faces the area of which is larger than the other faces, and a touch panel 2, an input unit 3, a contact sensor 4, a speaker 7, and a microphone 8, which are arranged on the surface of the housing.

The touch panel 2 is disposed on one of faces (a front face or a first face) having the largest area. The touch panel 2 displays a text, a graphic, an image, or the like, and, detects various operations (gestures) performed by a user on the touch panel 2 by using his/her finger, a stylus, a pen, or the like (in the description herein below, for the sake of simplicity, it is assumed that the user touches the touch panel 2 with his/her fingers). The detection method of the touch panel 2 may be any detection methods, including but not limited to, a capacitive type detection method, a resistive type detection method, a surface acoustic wave type (or ultrasonic type) detection method, an infrared type detection method, an electro magnetic induction type detection method, and a load sensing type detection method. The input unit 3 includes a plurality of buttons such as a button 3A, a button 3B, and a button 3C to which predetermined functions are assigned. The speaker 7 outputs a voice of a call opponent, music or an effect sound reproduced by various programs, and the like. The microphone 8 acquires a voice during a phone call or upon receiving an operation by a voice.

The contact sensor 4 is disposed on a face (a side face, a second face, or a third face opposite to the second face) that comes into contact with the face on which the touch panel 2 is disposed. The contact sensor 4 detects various operations that the user performs for the contact sensor 4 by using his/her finger. Under the assumption that the face on which the touch panel 2 disposed is the front face, the contact sensor 4 includes the right contact sensor 22 disposed on the right side face, the left contact sensor 24 disposed on the left side face, the upper contact sensor 26 disposed on the upper side face, and the lower contact sensor 28 disposed on the lower side face. The detection method of the right contact sensor 22 and the like may be any detection methods, including but not limited to, a capacitive type detection method, a resistive type detection method, a surface acoustic wave type (or ultrasonic type) detection method, an infrared type detection method, an electro magnetic induction type detection method, and a load sensing type detection method. Each of the right contact sensor 22, the left contact sensor 24, the upper contact sensor 26, and the lower contact sensor 28 can detect a multi-point contact. For example, when two fingers are brought into contact with the right contact sensor 22, the right contact sensor 22 can detect respective contacts of the two fingers at the positions with which the two fingers are brought into contact.

The mobile phone 1 includes the contact sensor 4 in addition to the touch panel 2 and thus can provide the user with various operation methods that are intuitive and superior in operability as will be described below.

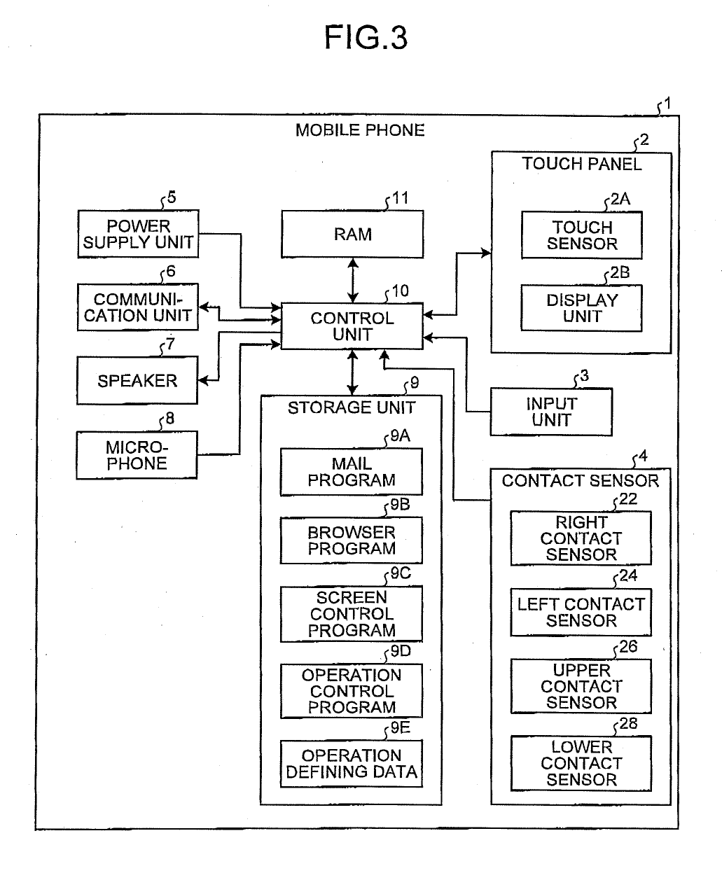

Next, a functional configuration of the mobile phone 1 will be described with reference to FIG. 3. FIG. 3 is a block diagram of the mobile phone 1. As illustrated in FIG. 3, the mobile phone 1 includes the touch panel 2, the input unit 3, the contact sensor 4, a power supply unit 5, a communication unit 6, the speaker 7, the microphone 8, a storage unit 9, a control unit 10, and a random access memory (RAM) 11.

The touch panel 2 includes a display unit 2B and a touch sensor 2A that is arranged on the display unit 2B in a superimposed manner. The touch sensor 2A detects various operations performed on the touch panel 2 using the finger as well as the position on the touch panel 2 at which the operation is made and notifies the control unit 10 of the detected operation and the detected position. Examples of the operations detected by the touch sensor 2A include a tap operation and a sweep operation. The display unit 2B is configured with, for example, a liquid crystal display (LCD), an organic electro-luminescence display (OELD), or the like and displays a text, a graphic, and so on.

The input unit 3 receives the user's operation through a physical button or the like and transmits a signal corresponding to the received operation to the control unit 10. The contact sensor 4 includes the right contact sensor 22, the left contact sensor 24, the upper contact sensor 26, and the lower contact sensor 28. The contact sensor 4 detects various operations performed on these sensors as well as the positions at which the operations are made, and notifies the control unit 10 of the detected operation and the detected position. The power supply unit 5 supplies electric power acquired from a battery or an external power supply to the respective functional units of the mobile phone 1 including the control unit 10.

The communication unit 6 establishes a wireless signal path using a code-division multiple access (CDMA) system, or any other wireless communication protocols, with a base station via a channel allocated by the base station, and performs telephone communication and information communication with the base station. Any other wired or wireless communication or network interfaces, e.g., LAN, Bluetooth, Wi-Fi, NFC (Near Field Communication) may also be included in lieu of or in addition to the communication unit 6. The speaker 7 outputs a sound signal transmitted from the control unit 10 as a sound. The microphone 8 converts, for example, the user's voice into a sound signal and transmits the converted sound signal to the control unit 10.

The storage unit 9 includes one or more non-transitory storage medium, for example, a nonvolatile memory (such as ROM, EPROM, flash card etc.) and/or a storage device (such as magnetic storage device, optical storage device, solid-state storage device etc.), and stores therein programs and data used for processes performed by the control unit 10. The programs stored in the storage unit 9 include a mail program 9A, a browser program 9B, a screen control program 9C, and an operation control program 9D. The data stored in the storage unit 9 includes operation defining data 9E. In addition, the storage unit 9 stores programs and data such as an operating system (OS) program for implementing basic functions of the mobile phone 1, address book data, and the like. The storage unit 9 may be configured with a combination of a portable storage medium such as a memory card and a storage medium reading device.

The mail program 9A provides a function for implementing an e-mail function. The browser program 93 provides a function for implementing a we browsing function. The screen control program 9C displays a text, a graphic, or the like on the touch panel 2 in cooperation with functions provided by the other programs. The operation control program 9D provides a function for executing processing according to various contact operations detected by the touch sensor 2A and the contact sensor 4. The operation defining data 9E maintains a definition on a function that is activated according to a detection result of the contact sensor 4.

The control unit 10 is, for example, a central processing unit (CPU) and integrally controls the operations of the mobile phone 1 to realize various functions. Specifically, the control unit 10 implements various functions by executing a command included in a program stored in the storage unit 9 while referring to data stored in the storage unit 9 or data loaded to the RAM 11 as necessary and controlling the display unit 2B, the communication unit 6, or the like. The program executed or the data referred to by the control unit 10 may be downloaded from a server apparatus through wireless communication through the communication unit 6.

For example, the control unit 10 executes the mail program 9A to implement an electronic mail function. The control unit 10 executes the operation control program 9D to implement a function for performing corresponding processing according to various contact operations detected by the touch sensor 2A and the contact sensor 4. The control unit 10 executes the screen control program 9C to implement a function for displaying a screen and the like used for various functions on the touch panel 2. In addition, it is assumed that the control unit 10 can execute a plurality of programs in a parallel manner through a multitasking function provided by the OS program.

The RAM 11 is used as a storage area in which a command of a program executed by the control unit 10, data referred to by the control unit 10, a calculation result of the control unit 10, and the like are temporarily stored.

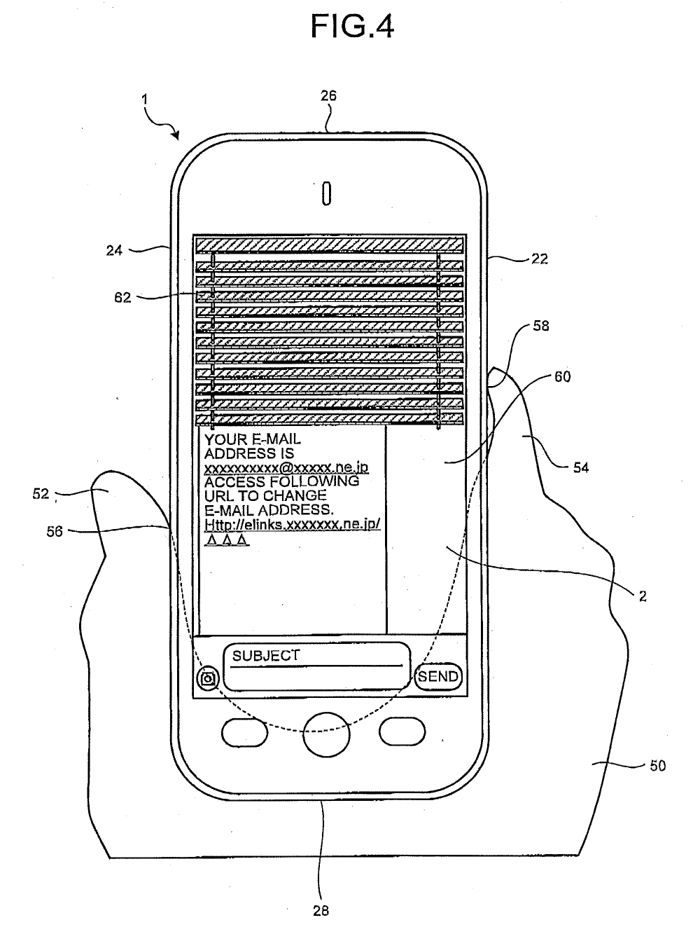

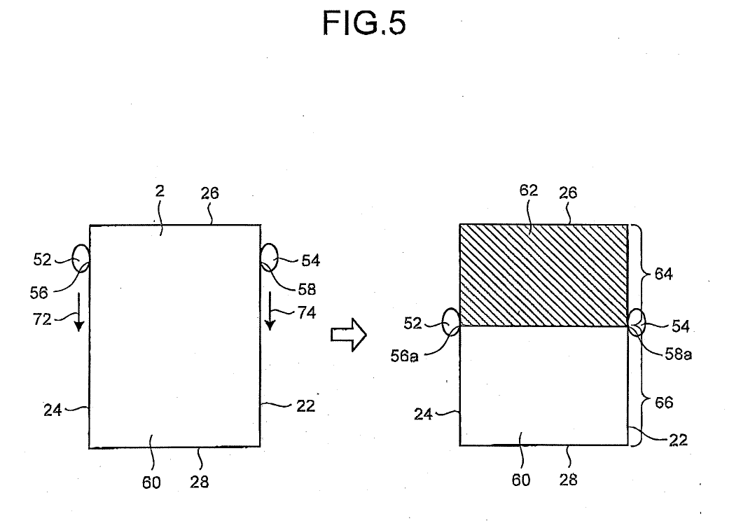

Next, an example of control executed by the control unit 10 according to an operation detected by the contact sensor 4 will be described with reference to FIGS. 4 and 5. FIGS. 4 and 5 are diagrams illustrating an example of control executed by the control unit according to an operation detected by the contact sensor, respectively. FIG. 4 is a diagram concretely illustrating a relation between the mobile phone 1 and a hand (a right hand 50) operating the mobile phone 1. FIG. 5 is a diagram schematically illustrating a relation among the contact sensor 4, a screen of an operation target, and the finger. In FIG. 5, a housing portion of the outer circumference of the touch panel 2 is not illustrated.

The mobile phone 1 illustrated in FIG. 4 is operated by the user's right hand in a direction in which a longitudinal direction of the touch panel 2 is a lengthwise direction (a vertical direction). The mobile phone 1 may be operated while being supported by the right hand; however, a back face (a face at a side opposite to a face on which the touch panel 2 is arranged) is preferably supported by the left hand. In the present embodiment, the user supports a portion of the left contact sensor 24 with the thumb 52 of the right hand 50 and supports a portion of the right contact sensor 22 with the index finger 54.

In a case of the state in which the two fingers come into contact with the contact sensor 4 as described above, the mobile phone 1 detects a contact at a contact point 56 of the thumb 52 through the left contact sensor 24, and detects a contact at a contact point 58 of the index finger 54 through the right contact sensor 22 as illustrated in the left drawing of FIG. 5. That is, the right contact sensor 22 detects a contact at the contact point 58, and the left contact sensor 24 detects a contact at the contact point 56. A difference between the position of the contact point 56 and the position of the contact point 58 in the longitudinal direction (a direction in which the right contact sensor 22 and the left contact sensor 24 extend) is within a certain distance. Thus, the contact point 56 and the contact point 58 can be connected to each other by a straight line parallel to a lateral direction. The straight line parallel to a lateral direction dose not have to passes through the corresponding contact points exactly, but the straight line preferably passes through near the corresponding contact points. In other words, preferably, the positions of the contact points can be approximated to connect to each other by a straight line parallel to the transverse direction. In the present embodiment, the straight line connecting the two contact points to each other is referred to as a contact position.

In the state illustrated in a left drawing of FIG. 5, an image 60 is displayed on an overall display area of the screen of the touch panel 2. The image (object) 60 is an operation target image (object), and various images can be used as the image 60. For example, a window image representing an execution screen of an arbitrary application may be used as the image (object) 60. The image 60 is configured with a text, a symbol, a picture, and the like. More specifically, examples of an operation target image include an image displayed at the time of mail composition, an image displayed by processing of a browser, and an image displayed at the time of schedule management.

In the state illustrated in the left drawing of FIG. 5, the user moves the thumb 52 in a direction of an arrow 72 and moves the index finger 54 in a direction of an arrow 74. In other words, the index finger 54 coming into contact with the right contact sensor 22 is moved in a direction closer to the lower contact sensor 28, and the thumb 52 coming into contact with the left contact sensor 24 is moved in a direction closer to the lower contact sensor 28. By moving the fingers as described above, the user moves the thumb 52 to the contact point 56a and moves the index finger 54 to the contact point 58a as illustrated in a right drawing of FIG. 5. In the present embodiment, an operation of moving two fingers (contact position) coming into contact with the contact sensor 4 while maintaining a contact with the contact sensor 4 as illustrated from the left drawing to the right drawing of FIG. 5 is referred to as a “shade operation.” An operation of moving a contact point while maintaining a contact with the contact sensor 4 may be referred to as a “sweep operation (slide operation).”

When the shade operation is input, the right contact sensor 22 detects an operation of moving the contact point 58 to the contact point 58a, and the left contact sensor 24 detects an operation of moving the contact point 56 to the contact point 56a. The contact sensor 4 notifies the control unit 10 of the detection result.

The control unit 10 changes an image displayed on the touch panel 2 based on a function provided by the operation control program 9D when the contact sensor 4 detects an operation of moving a contact position while maintaining a contact state as described above, that is, in the present embodiment, when the contact sensor 4 detects an operation of moving a straight line (contact position), which is parallel to the transverse direction, obtained by approximating contact points, which are opposite to each other, respectively detected by the right contact sensor 22 and by the left contact sensor 24. Specifically, the control unit 10 causes a shade image 62 to be displayed on an area 64 of the touch panel 2 as illustrated in FIG. 4 and the right drawing of FIG. 5. A part of the image 60 is displayed “as is” on an area 66 which is an area other than the area 64 of the touch panel 2. Thus, a portion of the image 60 corresponding to the area 64 is covered with the shade image 62. The shade image 62 refers to an image in which a plurality of spindly plates are arranged in the vertical direction of the screen (a direction in which the fingers move for the shade operation or a vertical direction on a paper plane of FIG. 4) as illustrated in FIG. 4. In other words, the shade image 62 refers to an image to which a so-called shade (blind), which is arranged on a window openably/closably and capable of blocking incident light from the outside by a configuration in which slats (louvers) are connected by a string or the like, is applied. The size of the area 64 is decided based on the sweep operation input as the shade operation.

As described above, when the contact sensor 4 detects the sweep operation of moving the contact position as the shade operation, the mobile phone 1 causes the shade image 62 to be displayed on an area of the touch panel 2 corresponding to movement of the contact position by the shade operation. Thus, the user can make a state in which a part of the image 60 displayed on the touch panel 2 is not viewed by the simple operation. Further, by using the sweep operation as the shade operation, an operation of sweeping (sliding) with fingers can be associated with processing of pulling a shade down. Accordingly, an intuitive operation can be implemented.

Further, by using an image of a shade in which a plurality of spindly plates are arranged in the vertical direction of the screen (in the direction of moving the fingers for the shade operation) as in the present embodiment, it can be intuitively understood that the target area is concealed. The shade image 62 is not limited to an image of a shade of the present embodiment. The shade image 62 may be an image configured such that visibility of the target area (the area 64 in FIG. 5) of the image 60, i.e., an image displayed before the shade operation is input is lowered and so a written or displayed content is illegible. For example, instead of the image 60 of the target area, a blurred image, i.e., an image of frosted glass may be displayed, or a black image may be displayed. The shade image may be configured such that another image such as a black image, an image of a shade, or the like is superimposed on an area of the image 60. More specifically, an image in which another image (an opaque image) is superimposed on the image 60 in at least an area other than the background is preferably used as the shade image. More preferably, an image in which another image (an opaque image) is superimposed on the whole surface of the target area is preferably used as the shade image. Thus, the target area can be more reliably concealed.

The mobile phone 1 preferably uses an image covering the whole area of the display area of the touch panel 2 in a direction perpendicular to a direction in which the contact position is moved by the shade operation as the shade image 62 as in the present embodiment. A range for displaying the shade image 62 in the direction in which the contact position is moved by the shade operation is decided based on the shade operation, and so the shade image 62 to be displayed can be decided.

Various methods can be used as a method of deciding the range for displaying the shade image 62 in the direction in which the contact position is moved by the shade operation based on the shade operation. For example, an upper end of the shade image 62 may be used as an upper end of the screen in a display direction (a text display direction) by default, and the contact position lastly detected by the sweep operation may be used as a lower end of the shade image 62.

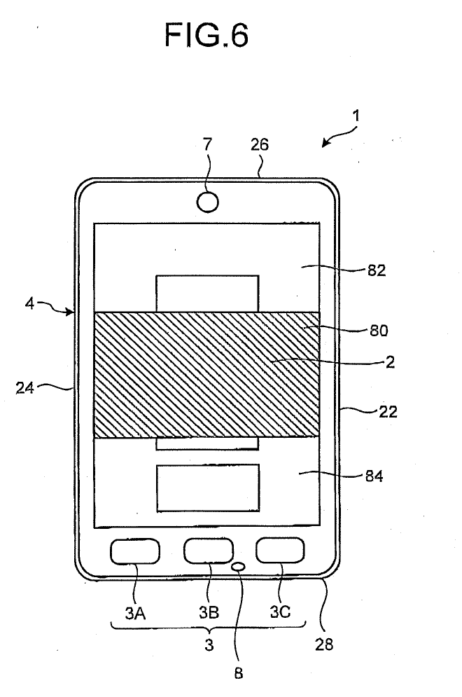

Next, another example of an area where a shade image is displayed will be described with reference to FIG. 6. FIG. 6 is a diagram illustrating an example of control executed by the control unit according to an operation detected by the contact sensor. In the above embodiment, the upper end of the shade image 62 is set to the upper end of the display area of the touch panel 2; however, the present invention is not limited thereto. As illustrated in FIG. 6, a shade image 80 may be displayed only on a middle portion of the display area of the touch panel 2 in the vertical direction of the screen. In this case, an image 82 is displayed on an area above the shade image 80, and an image 84 is displayed on an area below the shade image 80. As described above, the shade image 80 may be displayed on an arbitrarily set area other than an area including the upper end of the screen in the vertical direction of the screen. In this case, for example, a start point and an end point of the shade operation may be used as both ends of the shade image, and both ends of an area where the contact position is moved by the shade operation may be used as both ends of the shade image.

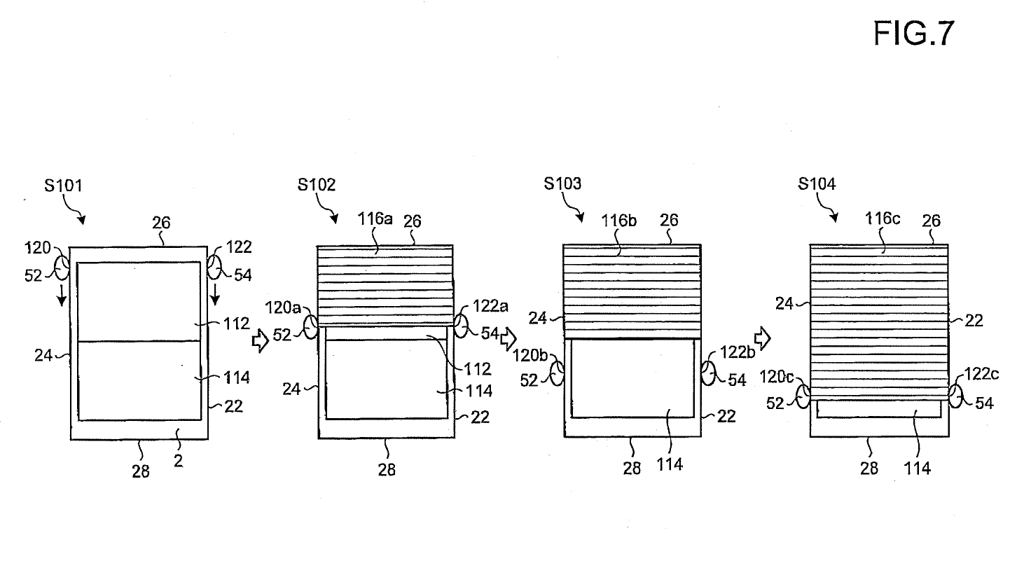

Next, another example of a method of deciding an area where a shade image is displayed will be described with reference to FIG. 7. FIG. 7 is a diagram illustrating an example of control executed by the control unit according to an operation detected by the contact sensor. First, as illustrated in step S101 of FIG. 7, the mobile phone 1 causes an image, which is configured with two elements of a first image 112 and a second image 114 arranged below the first image 112 in the vertical direction of the screen, to be displayed on the touch panel 2. For example, in case of an image displayed at the time of mail composition, the first image 112 may be an image displaying input character strings, and the second image 114 may be an image of a keyboard. The user comes into contact with a portion of the left contact sensor 24 at the upper contact sensor 26 side with the thumb 52, and comes into contact with a portion of the right contact sensor 22 at the upper contact sensor 26 side with the index finger 54. The left contact sensor 24 detects a contact at a contact point 120, and the right contact sensor 22 detects a contact at a contact point 122.

Subsequently, the user moves the thumb 52 and the index finger 54 toward the lower contact sensor 28 side from the contact points 120 and 122 illustrated in step S101 up to contact points 120a and 122a illustrated in step S102 through the sweep operation. The contact points 120a and 122a are at the upper position of a threshold distance or more from the boundary between the first image 112 and the second image 114. The mobile phone 1 detects the sweep operation of the thumb 52 and the index finger 54 as the shade operation, and so displays a shade image 116a extending from the upper end of the touch panel 2 to the position corresponding to the contact points 120a and 122a. The shade image 116a is extended such that its lower end is above a straight line obtained by connecting the contact points 120a and 122a to each other, and exposes a part of the lower end of the first image 112 while concealing the remaining area of the first image 112. The mobile phone 1 detects a straight line obtained by connecting a contact point of the thumb 52 and a contact point of the index finger 54 to each other as the contact position.

Subsequently, the user moves the thumb 52 and the index finger 54 toward the lower contact sensor 28 side from the contact points 120a and 122a illustrated in step S102 up to contact points 120b and 122b illustrated in step S103 through the sweep operation. The contact points 120b and 122b are at the position lower than the boundary between the first image 112 and the second image 114. A distance between a straight line (i.e., a contact position) obtained by connecting the contact point 120b and the contact point 122b to each other and the boundary is a threshold value or less. The mobile phone 1 detects the sweep operation as the shade operation, and displays a shade image 116b extending from the upper end of the touch panel 2 to the position corresponding to the contact points 120b and 122b. In this case, since the distance between the contact position and the boundary is a threshold value or less, the lower end of the shade image 116b is adjusted to a position (the boundary) between the first image 112 and the second image 114. That is, the shade image 116b is concealing the whole area of the first image 112 and exposing the whole area of the second image 114.

Subsequently, the user moves the thumb 52 and the index finger 54 toward the lower contact sensor 28 side from the contact points 120b and 122b illustrated in step S103 up to contact points 120c and 122c illustrated in step S104 through the sweep operation. The contact points 120c and 122c are at the lower position of a threshold value or more from the boundary between the first image 112 and the second image 114. The mobile phone 1 detects the sweep operation of the thumb 52 and the index finger 54 as the shade operation, and displays a shade image 116c extending from the upper end of the touch panel 2 to the position corresponding to the contact points 120c and 122c. The lower end of the shade image 116c is on a straight line obtained by connecting the contact points 120c and 122c to each other, and the shade image 116c exposes a part of the lower end of the second image 114 while concealing the remaining area of the second region 114 and the whole area of the first image 112.

As described above, when an end portion of a moving area in a moving direction of the contact position of the sweep operation is within a predetermined distance from between an element and an element of an image displayed on a touch panel, the end portion of the shade image is positioned between the element and the element, and thus the end portion of the shade image can be delimited at the appropriate position. Thus, a small part of the element can be prevented from being concealed by the shade image or from being not concealed by the shade image. In other words, the user can adjust whether or not each element is to be concealed by the simple operation. Further, the mobile phone 1 may be configured to prevent the contact position from being the position at which a small part of the element is concealed, that is, to avoid only the state where a small part of the element is concealed in a case as illustrated in step 5103. In other words, the shade image may not be arranged on an element until a predetermined area or more of the element is concealed.

In the above embodiment, the image displayed on the touch panel 2 includes the two elements; however, the number of elements is not particularly limited. The number of elements configuring the image displayed on the touch panel 2 may be analyzed by the control unit 10. The number of elements on an image may be set in advance.

When an image displayed on the touch panel 2 includes a sentence configured with multiple lines of character strings, the mobile phone 1 may position an end portion (an end portion at a side at which a position is adjusted or an end portion in a direction in which a contact position is moved) of the shade image between lines. In this case, a state in which a part of text is concealed and so unreadable or a state in which only a part of text is displayed and viewed can be avoided. Further, the user need not delicately adjust the position, and thus an operation is simplified.

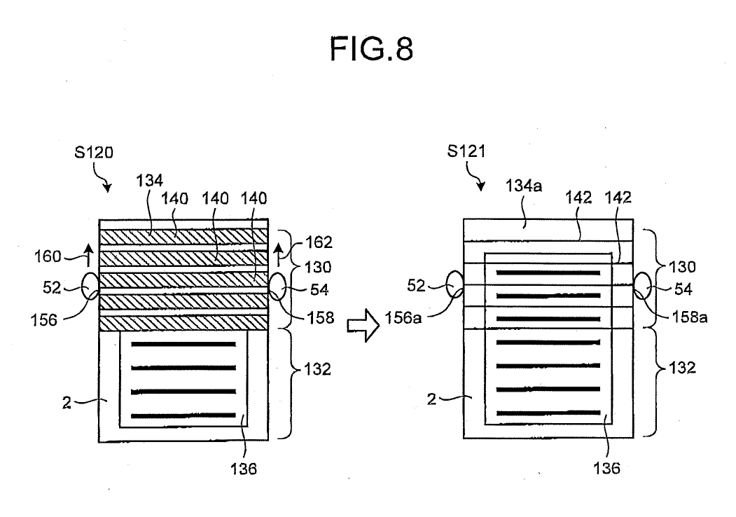

Next, a method of switching a display of a shade image will be described with reference to FIG. 8. FIG. 8 is a diagram illustrating an example of control executed by the control unit according to an operation detected by the contact sensor. As illustrated in step S120 of FIG. B, the mobile phone 1 displays a shade image 134 on an area 130 of the touch panel 2, and displays an image 136 on an area 132 below the area 130 in the vertical direction of the screen. The image 136 is an image that is stretched to the whole area of the touch panel 2, and its part in the area 130 is concealed by the shade image 134. The image 136 is an image including a text configured with multiple lines of character strings. The shade image 134 is an image in which a plurality of slats 140 having a spindly plate shape are arranged in a line in the vertical direction of the screen (in the direction in which the contact position is moved). The user comes into contact with the left contact sensor 24 with the thumb 52, and comes into contact with the right contact sensor 22 with the index finger 54. The left contact sensor 24 detects a contact at a contact point 156, and the right contact sensor 22 detects a contact at a contact point 158.

Subsequently, the user moves the thumb 52 and the index finger 54 in directions of arrows 160 and 162 (toward the upper side in the vertical direction of the screen) from the contact points 156 and 158 illustrated in step S120 up to contact points 156a and 158a illustrated in step S121 through the sweep operation. In other words, the sweep operation is performed by moving the contact position in a direction opposite to the moving direction of the shade operation. When the sweep operation of the thumb 52 and the index finger 54 in the directions of the arrows 160 and 162 is detected, the mobile phone 1 displays a shade image 134a instead of the shade image 134. The shade image 134a is an image in which slats 142 representing a state in which the slats 140 are rotated by 90 degrees are arranged in a line in the vertical direction of the screen (in the direction in which the contact position is moved). The slat 142 representing a state in which the slat 140 is rotated by 90 degrees is seen as a line. Further, the slat 142 is displayed between lines of multiple lines of the text configuring an image 136.

As described above, when the sweep operation is input in a direction opposite to the shade operation, the mobile phone 1 allows an image of an area, which was made invisible by a shade image (which was lowered in visibility), to be viewed. Thus, an image of an area which was made invisible by a shade image can be temporarily checked. In this way, an area concealed by a shade image can be checked by the simple operation. The above process is performed using the sweep operation in a direction opposite to the shade operation as a trigger, and thus a display of the screen can be switched by an operation similar to a shade operation of a window. When the shade operation is input again in a state in which an image of an area on which a shade image is arranged is allowed to be viewed, the mobile phone 1 makes the image of the area invisible by a shade image. Thus, the image of the area can be concealed by the shade image again.

The mobile phone 1 may switch control according to a moving amount of the contact position of the sweep operation in a direction opposite to the shade operation. For example, when the moving amount of the contact position is a threshold value or more, the position of a shade image is changed (an area where a shade image is arranged is reduced), whereas when the moving amount of the contact position is less than the threshold value, an image of an area which was made invisible by a shade image (which was lowered in visibility) is allowed to be viewed. In this way, an area on which a shade image is arranged can be adjusted.

An operation detected as the shade operation is not limited to the inputs illustrated in FIGS. 4 and 5. The control unit 10 may detect various operations for putting contact points, which are brought into contact with the contact sensor 4, closer to each other as the shade operation. An operation defined as the shade operation may be defined in the operation defining data 9E in advance. That is, an operation for putting contact points, which are brought into contact with the contact sensor 4, closer to each other may be defined as an operation other than the shade operation.

For example, in the above embodiment, contact points are detected by the right contact sensor 22 and the left contact sensor 24, respectively, and a straight line obtained by connecting two contact points to each other is detected as the contact position. However, a contact point detected by any one sensor of the contact sensor 4 may be detected as the contact position. In this case, the mobile phone 1 may detect the sweep operation of the contact point detected by one contact sensor as the shade operation.

As described above, the mobile phone 1 preferably uses a straight line, which is obtained by approximating and connecting contact points detected by opposite two contact sensors of the contact sensor 4 and which is perpendicular to the contact sensors, as at least one of contact positions of the shade operation. Thus, various processes can be allocated to other operations that can be detected by the contact sensor 4.

Further, as illustrated in FIGS. 4 and 5, the mobile phone 1 preferably uses a straight line, which is obtained by connecting a contact point detected by one contact sensor with a contact point detected by the other contact sensor, as one of two contact positions. Thus, an operation similar to an operation of pulling a shade down can be used as the shade operation. Thus, processing to be executed in response to an input operation is intuitively easily understood.

The control unit 10 may detect a hand holding the housing based on information of a contact detected by the contact sensor 4, and extract only a contact of a hand not holding the housing to determine whether or not an operation input by the contact is the shade operation. In this case, when the sweep operation by the contact of the hand not holding the housing is detected, it is determined that the shade operation has been input, and so a shade image is displayed. As described above, an operation is determined in view of a hand that has input an operation, and thus more operations can be input.

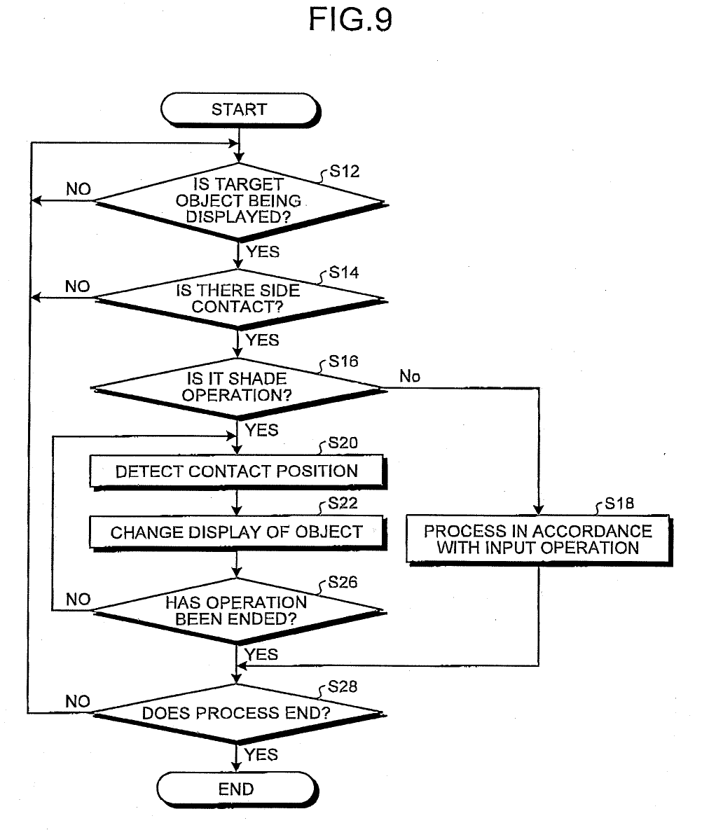

Next, an operation of the mobile phone 1 when a contact operation is detected will be described with reference to FIG. 9. FIG. 9 is a flowchart illustrating an operation of the mobile phone 1. A processing procedure illustrated in FIG. 9 is repetitively executed based on a function provided by the operation control program 9D.

At step S12, the control unit 10 of the mobile phone 1 determines whether a target object is being displayed. The target object refers to an object which can be used as an operation target of the shade operation. When it is determined that the target object is not being displayed (No at step S12), the control unit 10 proceeds to step S12. That is, the control unit 10 repeats processing of step S12 until the target object is displayed.

When it is determined that the target object is being displayed (Yes at step S12), at step S14, the control unit 10 determines whether there is a side contact, that is, whether a contact on any one side face has been detected by the contact sensor 4. When it is determined that there is no side contact (No at step S14), that is, when it is determined that a contact on a side face has not been detected, the control unit 10 returns to step S12. When it is determined that there is a side contact (Yes at step S14), that is, when it is determined that a contact on a side face has been detected, at step S16, the control unit 10 determines whether the contact is the shade operation.

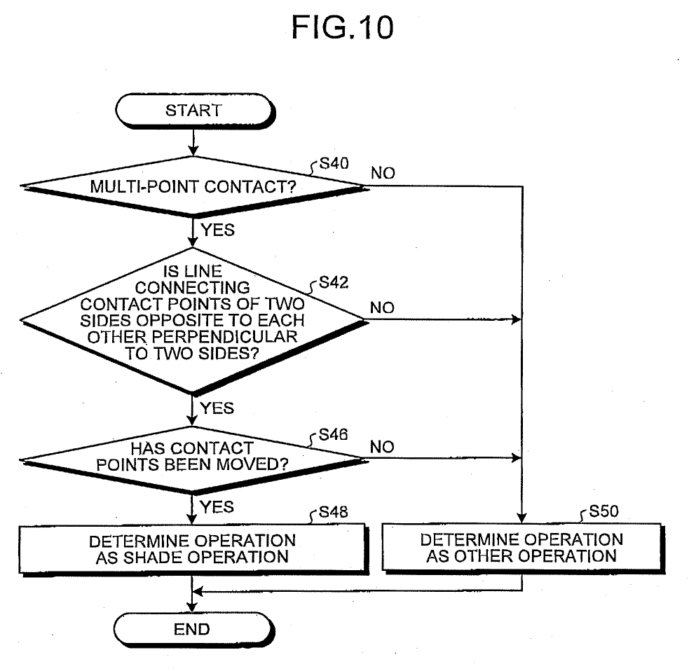

The determination of step S16 will be described with reference to FIG. 10. FIG. 10 is a flowchart illustrating an operation of the mobile phone 1. The process illustrated in FIG. 10 is based on when the operation illustrated in FIG. 4 is defined as the shade operation. At step S40, the control unit 10 determines whether the contact is a multi-point contact. That is, it is determined whether two or more contacts have been detected by the contact sensor 4. When it is determined that the contact is not the multi-point contact (No at step S40), the control unit 10 proceeds to step S50.

When it is determined that the contact is the multi-point contact (Yes at step S40), at step S42, the control unit 10 determines whether a line obtained by connecting contact points of corresponding two sides (two faces) to each other is a line that is substantially perpendicular to the two sides. In other words, it is determined whether contact points having a relation such that a line perpendicular to two sides passes through the approximated points thereof are present on opposite two sides. When it is determined that the line is not substantially perpendicular to the two sides (No at step S42), the control unit 10 proceeds to step S50.

When it is determined that the line is substantially perpendicular to the two sides (Yes at step S42), at step S46, the control unit 10 determines whether contact points configuring the line (contact position) substantially perpendicular to the two sides have been moved, that is, whether the sweep operation has been performed. When it is determined that the contact points have not been moved (No at step S46), the control unit 10 proceeds to step S50.

When it is determined that the contact points configuring the line substantially perpendicular to the two sides have been moved (Yes at step S46), the control unit 10 determines that the detected operation is the shade operation. When the determination result of steps S40, S42, or S46 is No, at step S50, the control unit 10 determines that the detected operation is any other operation, that is, that the detected operation is not the shade operation. When the process of step S48 or S50 is executed, the control unit 10 ends the present determination process. Further, the control unit 10 may change the determination method according to an operation defined as the shade operation.

Returning to FIG. 9, the description of the present process is continued. When it is determined that the contact is not the shade operation (No at step S16), at step S18, the control unit 10 executes processing in accordance with the input operation. The control unit 10 compares a correspondence relation stored in the operation defining data 9E with the input operation to specify processing to be executed. Thereafter, the control unit 10 executes the specified processing and then proceeds to step 328.

Meanwhile, when it is determined that the contact is the shade operation (Yes at step S16), at step S20, the control unit 10 detects the contact position. More specifically, a moving history of the contact position is detected. When the contact position is detected at step S20, at step S22, the control unit 10 changes a display of the object. Specifically, the control unit 10 decides an area based on information of the contact position calculated at step S20, and displays a shade image on the decided area.

After the process of step S22 is performed, at step S26, the control unit 10 determines whether the shade operation has ended. The determination as to whether the shade operation has ended can be made based on various criteria. For example, when a contact is not detected by the contact sensor 4, it can be determined that the shade operation has ended.

When it is determined that the shade operation has not ended (No at step S26), the control unit 10 proceeds to step 320. The control unit 10 repeats the display change process according to the moving distance until the shade operation ends. When it is determined that the shade operation has ended (Yes at step S26), the control unit 10 proceeds to step S28.

When processing of step S18 has been performed or when the determination result of step S26 is Yes, at step S28, the control unit 10 determines whether the process ends, that is, whether operation detection by the contact sensor 4 is ended. When it is determined that the process does not ended (No at step S28), the control unit 10 returns to step S12. When it is determined that the process ends (Yes at step 328), the control unit 10 ends the present process.

The mobile phone 1 according to the present embodiment is configured to receive an operation on a side face and execute processing according to the operation received at the side face, thereby providing the user with various operation methods. In other words, as illustrated in FIG. 9, when the contact detected by the contact sensor is not the shade operation, by executing processing according to the input, various operations can be input. For example, processing of zooming in a displayed image or a screen scroll operation may be performed on a sweep operation of a contact point detected by a contact sensor of one side (one face). When contact points are detected at corresponding positions (positions configuring a line substantially perpendicular to two sides) of opposite two sides as in the operation illustrated in FIG. 4, processing of displaying a shade image may be performed on a sweep operation of a contact position obtained by connecting the contact points to each other. Scrolling (scroll operation) of an image may be associated with a sweep operation of a contact point detected by a contact sensor of one side (one face), and the shade operation may be associated with another sweep operation.

An aspect of the present invention according to the above embodiment may be arbitrarily modified in a range not departing from the gist of the present invention.

In the above embodiment, the contact sensors are arranged on four sides (four side faces) of the housing as the contact sensor 4; however, the present invention is not limited thereto. The contact sensor that detects a contact on a side face is preferably arranged at a necessary position. For example, when the processes of FIGS. 4 and 5 are performed, the contact sensors may be arranged only on opposite two sides (two faces). In this case, the two contact sensors are preferably arranged on two side faces (that is, of long sides) adjacent to the long side of the front face (the face on which the touch panel is arranged). Thus, movement of the finger described with reference to FIGS. 4 and 5 can be used as the shade operation, an operation can be easily input, and thus operability can be improved.

The above embodiment has been described in connection with the example in which the present invention is applied to an electronic device having a touch panel as a display unit. However, the present invention can be applied to an electronic device including a simple display panel on which a touch sensor is not superimposed.

In the present embodiment, the contact sensor 4 is used as a contact detecting unit; however, the contact detecting unit is not limited thereto. The touch sensor 2A of the touch panel 2 may be used as the contact detecting unit. In other words, when a sweep operation of a contact position defined as the shade operation is input to the touch panel 2, a shade image may be displayed.

In the above embodiment, the sweep operation is used as the shade operation in order to implement a more intuitive operation. However, the present invention is not limited thereto. Various operations capable of specifying a display area of a shade image can be used as the shade operation. For example, a click operation or a touch operation of twice or more for designating an end of a shade image may be used as the shade operation, and an operation for instructing a direction of a directional key or the like may be used as the shade operation. Though any operation is input as the shade operation, by displaying a shade image on an area designated by the user, an image can be made invisible, and thus a peeping possibility can be reduced. Further, the user can arbitrarily set and adjust a display area of a shade image, and thus the user can conceal only a desired area.

The advantages are that one embodiment of the invention provides an electronic device, an operation control method, and an operation control program capable of reducing, by a simple operation, a possibility that a display content will be peeped.

What is claimed is:

1. An electronic device, comprising:
a display unit for displaying a first image;
a contact detecting unit for detecting a contact;
a control unit for causing, when a sweep operation is detected by the contact detecting unit while the first image is displayed on the display unit, a second image to be displayed over the first image, the second image being extended from a first position at which the sweep operation is detected at first or an end portion of the display unit near the first position.

2. The electronic device according to claim 1,
wherein the control unit is configured to maintain a display of the second image even when separation of a contact by the sweep operation is detected by the contact detecting unit.

3. The electronic device according to claim 1, further comprising a housing having a first face, on which the display unit is arranged, and second and third faces interposing the first face therebetween,
wherein the contact detecting unit includes a first detecting unit arranged on the second face and a second detecting unit arranged on the third face, and
the control unit is configured to cause the second image to be displayed on the display unit when the sweep operation is detected by both the first detecting unit and the second detecting unit.

4. The electronic device according to claim 3,
wherein the control unit is configured to cause the first image to be scrolled when the sweep operation is detected by either one of the first detecting unit or the second detecting unit.

5. The electronic device according to claim 3,
wherein the control unit is configured to cause, when another sweep operation in a direction opposite to the sweep operation is detected by the contact detecting unit while the second image is displayed on the first image, the first image to be visible.

6. The electronic device according to claim 5,
wherein the second image is an image in which a plurality of spindly plates are arranged, and
the control unit is configured to change the spindly plate into a line shape to change the second image.

7. The electronic device according to claim 6,
wherein the first image is an image including multiple lines of character strings, and
the control unit is configured to change the second image such that each of spindly plates changed into the line shape arranged between the lines of the character strings.

8. An operation control method executed by an electronic device including a display unit and a contact detecting unit, the operation control method comprising:
displaying a first image on the display unit;
detecting a sweep operation by the contact detecting unit while the first image is displayed on the display unit; and
displaying a second image over the first image when the sweep operation is detected, the second image being extended from a first position at which the sweep operation is detected at first or an end portion of the display unit near the first position.

9. The operation control method according to claim 8,
wherein the electronic device further includes a housing having a first face, on which the display unit is arranged, and second and third faces interposing the first face therebetween,
the contact detecting unit includes a first detecting unit arranged on the second face and a second detecting unit arranged on the third face, and
the sweep operation is detected by both the first detecting unit and the second detecting unit.

10. A non-transitory storage medium that stores an operation control program causing, when executed by an electronic device which includes a display unit and a contact detecting unit, the electronic device to execute:
displaying a first image on the display unit;
detecting a sweep operation by the contact detecting unit while the first image is displayed on the display unit; and
displaying a second image over the first image when the sweep operation is detected, the second image being extended from a first position at which the sweep operation is detected at first or an end portion of the display unit near the first position.
